(19) United States
(12) Patent Application Publication
(10) Pub. No.: US 2026/0244441 A1
(43) Pub. Date: Aug. 20, 2026

(54) METHOD OF CONTROLLING DISPLAY APPARATUS AND DISPLAY SYSTEM

(71) Applicant: SEIKO EPSON CORPORATION, Tokyo (JP)

(72) Inventors: Akihiro NAKASHIMA, BEPPU-SHI (JP); Masaki MIZOMORI, OITA-SHI (JP)

(21) Appl. No.: 19/541,586

(22) Filed: Feb. 17, 2026

(30) Foreign Application Priority Data
Feb. 18, 2025 (JP) 2025-024030

(51) Int. Cl. G06F 9/30

(52) U.S. Cl. CPC G06F 9/3001

(57) ABSTRACT

A method of controlling a display apparatus includes, before one or more processors of the display apparatus that displays an image start first arithmetic processing, displaying a recommended image for recommending use of an external arithmetic device different from the display apparatus as the image in order to execute at least a part of the first arithmetic processing.

The present application is based on, and claims priority from JP Application Serial Number 2025-024030, filed February 18, 2025, the disclosure of which is hereby incorporated by reference herein in its entirety.

### BACKGROUND

### 1. Technical Field

The present disclosure relates to a method of controlling a display apparatus and a display system.

### 2. Related Art

A projector disclosed in JP-A-2011-154069 includes a light source driver that drives a light source lamp, a main CPU that integrally controls the projector, and a sub-CPU that assists control of the main CPU and controls the light source driver. The calculation performed by the projector is shared by the main CPU and the sub-CPU.

JP-A-2011-154069 is an example of the related art.

When it is desired to share the calculation of the projector using an external arithmetic device, not share by the main CPU and the sub-CPU, it is difficult for a user to determine the timing and the situation in which the external arithmetic device should be used.

### SUMMARY

A method of controlling a display apparatus according to an aspect of the present disclosure includes, before one or more processors of the display apparatus that displays an image start first arithmetic processing, displaying a recommended image for recommending use of an external arithmetic device different from the display apparatus as the image in order to execute at least a part of the first arithmetic processing.

A display system according to an aspect of the present disclosure includes a display apparatus including one or more processors, and, before starting first arithmetic processing, displaying a recommended image for recommending use of an external arithmetic device different from the display apparatus in order to execute at least a part of the first arithmetic processing, and the external arithmetic device.

### BRIEF DESCRIPTION OF THE DRAWINGS

FIG. 1 is a block diagram showing a configuration example of a display system 1.

FIG. 2 is a block diagram showing a configuration example of a projection apparatus 10.

FIG. 3 is a flowchart showing an operation example of the display system 1.

FIG. 4 is a block diagram showing a configuration example of a display system 1A.

### DESCRIPTION OF EMBODIMENTS

Hereinafter, embodiments for implementing the present disclosure will be described with reference to the drawings. In the respective drawings, dimensions and scales of the respective parts are made different from real ones as appropriate. The embodiments described below are preferable specific examples of the present disclosure, and various technically preferable limitations are therefore imposed on the embodiments. However, the scope of the present disclosure is not limited to the embodiments unless there is some description that particularly limits the present disclosure in the following description.

### 1: First Embodiment

### 1-1: Configuration of First Embodiment

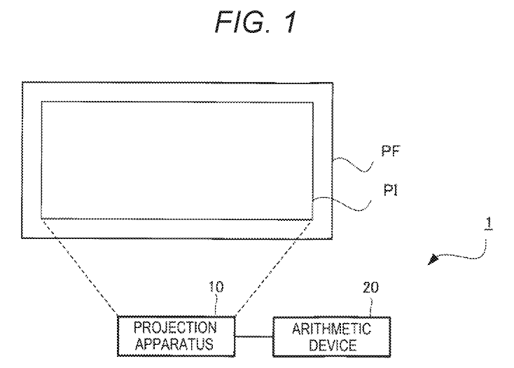

Hereinafter, a display system 1 according to a first embodiment will be described with reference to FIGS. 1 to 3.

### 1-1-1: Overall Configuration

FIG. 1 is a block diagram showing a configuration example of the display system 1. The display system 1 includes a projection apparatus 10 and an arithmetic device 20.

The projection apparatus 10 projects a projection image PI on a projection surface PF. The projection apparatus 10 may execute multi-projection together with another projection apparatus 10 that projects another projection image PI on the projection surface PF. The projection apparatus 10 is an example of a "display apparatus".

The arithmetic device 20 is an arithmetic device as an external device of the projection apparatus 10. When the projection apparatus 10 attempts to execute a calculation for geometric correction, but the performance of the projection apparatus 10 is insufficient and the calculation speed is slow or there is room for improvement in accuracy, the arithmetic device 20 executes at least a part of the calculation that the projection apparatus 10 initially attempted to execute.

The connection between the projection apparatus 10 and the arithmetic device 20 may be established before the projection apparatus 10 starts the above calculation or not. The connection may be a wired connection or a wireless connection.

The arithmetic device 20 is, for example, a mini personal computer (PC) such as Raspberry Pi (registered trademark).

### 1-1-2: Configuration of Projection Apparatus 10

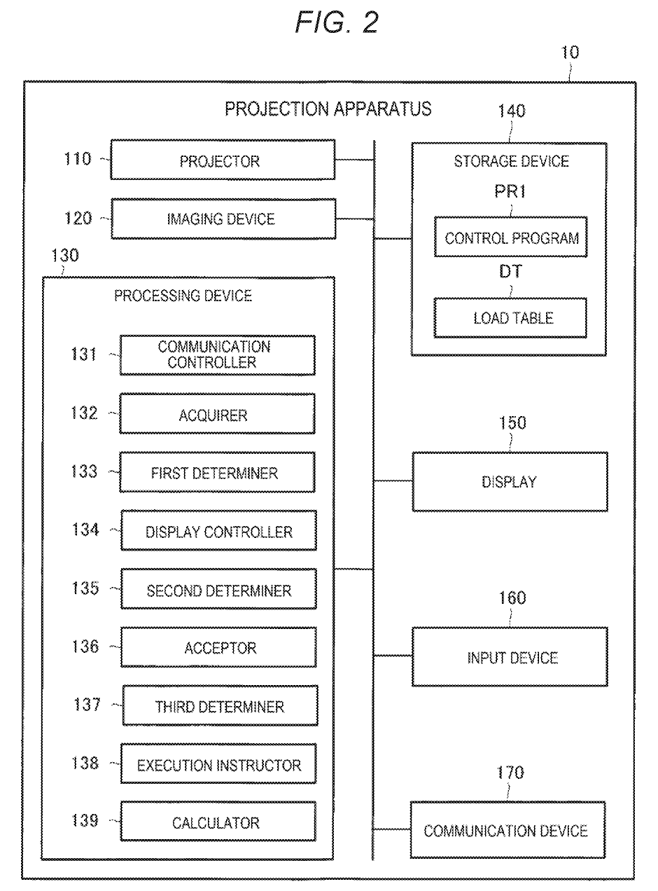

FIG. 2 is a block diagram showing a configuration example of the projection apparatus 10.

The projection apparatus 10 includes a projector 110, an imaging device 120, a processing device 130, a storage device 140, a display 150, an input device 160, and a communication device 170. The elements of the projection apparatus 10 are connected to one another via a single bus or a plurality of buses for communicating information. The elements of the projection apparatus 10 may include one or a plurality of devices and some elements of the projection apparatus 10 may be omitted.

The projector 110 is a device that projects an image acquired by an acquirer 132 described later on the projection surface PF. The projector 110 projects various images under the control of the processing device 130. The projector 110 includes, for example, a light source, a liquid crystal panel, and a projection lens, modulates light from the light source using the liquid crystal panel, and projects the modulated light onto a screen, a wall, or the like via the projection lens. The liquid crystal panel is an example of a light modulation element.

The imaging device 120 is a device that images the outside world of the projection apparatus 10. In the present embodiment, the imaging device 120 images the projection surface PF. The imaging device 120 includes an imaging lens and an imaging element such as a complementary metal-oxide-semiconductor (CMOS) sensor or a charge-coupled device (CCD) sensor that converts image light incident through the imaging lens into imaging data. The imaging device 120 is, for example, a camera built in the projection apparatus 10. However, as another example, the imaging device 120 may be an external camera such as a WEB camera.

The processing device 130 includes one or more processors that control the entire projection apparatus 10 configured with, for example, a single chip or a plurality of chips. The processing device 130 includes, for example, a central processing unit (CPU) including an interface with peripheral devices, an arithmetic operation device, and a register. Part or all of the functions of the processing device 130 may be implemented by hardware such as a digital signal processor (DSP), an application specific integrated circuit (ASIC), a programmable logic device (PLD), or a field programmable gate array (FPGA). The processing device 130 executes various kinds of processing in parallel or in sequence.

The storage device 140 is a recording medium readable by the processing device 130 and stores a plurality of programs including a control program PR1 to be executed by the processing device 130. The storage device 140 stores a compile language program describing a procedure of arithmetic processing to be executed by the processing device 130. Further, the storage device 140 may store the projection image PI to be projected by the projection apparatus 10.

The storage device 140 may include, for example, at least one of a read only memory (ROM), an erasable programmable ROM (EPROM), an electrically erasable programmable ROM (EEPROM), and a random access memory (RAM). The storage device 140 may be referred to as a register, a cache, a main memory, a main storage device, or the like.

The storage device 140 stores a load table DT. The load table DT is a table that associates the type of calculation executed by the processing device 130 with the load of the calculation. In the load table DT, for example, the type of calculation such as "geometric correction" or "color calibration" and the load of each calculation are stored in association with each other.

The display 150 is a device that displays an image and character information. The display 150 displays various images under the control of the processing device 130. For example, various display panels such as a liquid crystal display panel and an organic electroluminescence (EL) display panel are suitably used as the display 150.

The input device 160 is a device that receives operation of a user. For example, the input device 160 includes a pointing device such as a keyboard, a touch pad, a touch panel, or a mouse. When the input device 160 including a touch panel may also serve as the display 150.

The communication device 170 is hardware serving as a transmitting and receiving device for communication with the other devices. The communication device 170 is also called, for example, a network device, a network controller, a network card, or a communication module. The communication device 170 may include a connector for wired connection and an interface circuit for the connector. The communication device 170 may include a wireless communication interface. Examples of the connector for wired connection and the interface circuit include those compliant with wired LAN, IEEE 1394, and USB. Examples of the wireless communication interface include those compliant with wireless LAN and Bluetooth (registered trademark).

The processing device 130 functions as a communication controller 131, the acquirer 132, a first determiner 133, a display controller 134, a second determiner 135, a receiver 136, a third determiner 137, an execution instructor 138, and a calculator 139 by reading and executing the control program PR1 from the storage device 140. Note that the control program PR1 may be transmitted from another device such as a server that manages the projection apparatus 10 via a communication network NET.

The communication controller 131 controls the communication device 170 to cause the communication device 170 to transmit and receive various types of information to and from an external device. The external device includes the arithmetic device 20. The information that the communication controller 131 causes the communication device 170 to receive from the arithmetic device 20 includes information acquired by the acquirer 132 described later. The information that the communication controller 131 causes the communication device 170 to transmit to the arithmetic device 20 includes instruction information generated by the execution instructor 138 described later.

The acquirer 132 refers to the load table DT stored in the storage device 140 based on the type of arithmetic processing to be executed, and acquires a numerical value indicating the load corresponding to the arithmetic processing. The arithmetic processing is an example of "first arithmetic processing".

The first determiner 133 compares the numerical value indicating the load acquired by the acquirer 132 with a threshold, and determines whether to display a recommended image recommended to use the arithmetic device 20 in order to cause the arithmetic device 20 to execute at least a part of the arithmetic processing described above on the projection surface PF based on the result of the comparison.

The recommended image is preferably an image suggesting that the performance of the arithmetic processing of the display system 1 as a whole is improved by using the arithmetic device 20. The "performance of the arithmetic processing" here is, for example, a short processing time or high accuracy of a processing result.

Furthermore, the recommended image is preferably an image suggesting that the load of the display system 1 as a whole is reduced by using the arithmetic device 20.

Specifically, when the numerical value indicating the load is equal to or more than the threshold, the first determiner 133 determines to display the recommended image on the projection surface PF. When the first determiner 133 determines to display the recommended image on the projection surface PF, the display controller 134 projects the recommended image on the projection surface PF to display the recommended image on the projection surface PF. More specifically, the display controller 134 causes the projector 110 to project the projection image PI representing the recommended image onto the projection surface PF.

In contrast, when the numerical value indicating the load is less than the threshold, the first determiner 133 determines not to display the recommended image on the projection surface PF. When the first determiner 133 determines not to display the recommended image on the projection surface PF, the calculator 139 described later executes the arithmetic processing described above. In this case, the projection apparatus 10 and the arithmetic device 20 do not share the arithmetic processing, and the projection apparatus 10 alone executes the arithmetic processing.

After the connection between the projection apparatus 10 and the arithmetic device 20 is established for the user who visually recognized the recommended image to use the arithmetic device 20, the second determiner 135 determines whether the arithmetic device 20 satisfies a condition for executing at least a part of the arithmetic processing.

As an example, after the arithmetic device 20 is connected to the projection apparatus 10 and before the second determiner 135 determines whether the arithmetic device 20 satisfies the condition for executing at least a part of the arithmetic processing, the acquirer 132 acquires performance information indicating arithmetic performance of the arithmetic device 20 from the arithmetic device 20. The arithmetic performance of the arithmetic device 20 is an example of "first arithmetic performance".

In this case, the second determiner 135 determines whether the arithmetic performance indicated by the above performance information is equal to or more than arithmetic performance of the processing device 130 as the above-described condition. The arithmetic performance of the processing device 130 is an example of "second arithmetic performance".

When determining that the arithmetic performance indicated by the above-described performance information is equal to or more than the arithmetic performance of the processing device 130, the second determiner 135 determines that the arithmetic device 20 satisfies the condition. In contrast, when determining that the arithmetic performance indicated by the above-described performance information is less than the arithmetic performance of the processing device 130, the second determiner 135 determines that the arithmetic device 20 does not satisfy the condition.

As another example, after the arithmetic device 20 is connected to the projection apparatus 10 and before the second determiner 135 determines whether the arithmetic device 20 satisfies the condition for executing at least a part of the arithmetic processing, the acquirer 132 acquires license information from the arithmetic device 20. The license information indicates whether the arithmetic device 20 has a license of application software for executing at least a part of the arithmetic processing.

In this case, the second determiner 135 determines whether the arithmetic device 20 has the license based on the license information as the condition. More specifically, as an example, the second determiner 135 determines whether the arithmetic device 20 has a license of application software with better performance in order to execute at least a part of the above-described arithmetic processing.

When determining that the arithmetic device 20 has the license based on the license information, the second determiner 135 determines that the arithmetic device 20 satisfies the condition. In contrast, when determining that the arithmetic device 20 does not have the license based on the license information, the second determiner 135 determines that the arithmetic device 20 does not satisfy the condition.

As another example, after the arithmetic device 20 is connected to the projection apparatus 10 and before the second determiner 135 determines whether the arithmetic device 20 satisfies the condition for executing at least a part of the arithmetic processing, the acquirer 132 acquires the installation information from the arithmetic device 20. The installation information indicates whether application software for executing at least a part of the arithmetic processing is installed in the arithmetic device 20.

In this case, the second determiner 135 determines whether the application software is installed in the arithmetic device 20 based on the installation information as the condition. More specifically, as an example, the second determiner 135 determines whether application software with better performance is installed for the arithmetic device 20 to execute at least a part of the arithmetic processing.

When determining that the application software is installed in the arithmetic device 20 based on the installation information, the second determiner 135 determines that the arithmetic device 20 satisfies the condition. In contrast, when determining that the application software is not installed in the arithmetic device 20 based on the installation information, the second determiner 135 determines that the arithmetic device 20 does not satisfy the condition.

As another example, after the arithmetic device 20 is connected to the projection apparatus 10 and before the second determiner 135 determines whether the arithmetic device 20 satisfies a condition for executing at least a part of the arithmetic processing, the acquirer 132 acquires GPU (Graphics Processing Unit) information from the arithmetic device 20. The GPU information indicates a provision status of a GPU in the arithmetic device 20.

In this case, the second determiner 135 determines whether the GPU is provided in the arithmetic device 20 based on the GPU information as the condition.

When determining that the GPU is provided in the arithmetic device 20 based on the GPU information, the second determiner 135 determines that the arithmetic device 20 satisfies the condition. In contrast, when determining that the GPU is not provided in the arithmetic device 20 based on the GPU information, the second determiner 135 determines that the arithmetic device 20 does not satisfy the condition.

As described above, the acquirer 132 acquires at least one of the performance information, the license information, the installation information, and the GPU information from the arithmetic device 20. In order to enable the acquirer 132 to acquire these pieces of information, as an example, it is preferable that application software for transmitting these pieces of information to the projection apparatus 10 is installed in the arithmetic device 20.

As described above, the second determiner 135 determines whether the arithmetic device 20 satisfies the above-described condition based on each of the performance information, the license information, the installation information, and the GPU information. When the acquirer 132 acquires a plurality of pieces of information among the performance information, the license information, the installation information, and the GPU information, the second determiner 135 may determine whether the arithmetic device 20 satisfies the condition based on the plurality of pieces of information.

As an example, it is assumed that the acquirer 132 acquires two pieces of information of the performance information and the license information.

When determining that the arithmetic performance indicated by the performance information is equal to or more than the arithmetic performance of the processing device 130 or determines that the arithmetic device 20 has the license based on the license information, the second determiner 135 may determine that the arithmetic device 20 satisfies the condition. That is, the second determiner 135 may determine that the arithmetic device 20 satisfies the condition when the result of one of the determinations is positive. In the other cases, the second determiner 135 may determine that the arithmetic device 20 does not satisfy the condition.

Alternatively, when determining that the arithmetic performance indicated by the performance information is equal to or more than the arithmetic performance of the processing device 130 and determines that the arithmetic device 20 has the license based on the license information, the second determiner 135 may determine that the arithmetic device 20 satisfies the condition. That is, the second determiner 135 may determine that the arithmetic device 20 satisfies the condition only when both determination results are positive. In the other cases, the second determiner 135 may determine that the arithmetic device 20 does not satisfy the condition.

When the second determiner 135 determines that the arithmetic device 20 satisfies the condition, the display controller 134 displays a selection image that receives an answer for the arithmetic device 20 to execute at least a part of the arithmetic processing or an answer for the arithmetic device not to execute the arithmetic processing from the user on the projection surface PF. More specifically, the display controller 134 controls the projector 110 to project the projection image PI representing the selection image described above onto the projection surface PF.

The answer for the arithmetic device 20 to execute at least a part of the arithmetic processing is an example of a "first answer". In contrast, the answer for the arithmetic device 20 not to execute at least a part of the arithmetic processing is an example of a "second answer".

When the second determiner 135 determines that the arithmetic device 20 does not satisfy the condition, the display controller 134 displays a notification image for notifying the arithmetic device 20 to stop sharing at least a part of the arithmetic processing on the projection surface PF. More specifically, the display controller 134 causes the projector 110 to project the projection image PI representing the notification image described above onto the projection surface PF.

The receiver 136 receives the first answer or the second answer from the user via the selection image. Specifically, as an example, the receiver 136 receives the first answer or the second answer based on an operation on the input device 160 by the user.

The third determiner 137 determines whether the receiver 136 has received the first answer or the second answer via the selection image.

When the third determiner 137 determines that the first answer has been received, the execution instructor 138 instructs the arithmetic device 20 to execute at least a part of the arithmetic processing. Specifically, the execution instructor 138 causes the communication device 170 to transmit instruction information indicating an instruction to execute at least a part of the arithmetic processing to the arithmetic device 20. When receiving the instruction information, the arithmetic device 20 executes the at least a part of the arithmetic processing. Further, the execution instructor 138 instructs the calculator 139, which will be described later, to execute the remaining arithmetic processing among the above-described arithmetic processing.

In contrast, when the third determiner 137 determines that the second response has been received, the execution instructor 138 instructs the calculator 139, which will be described later, to execute all of the above-described arithmetic processing.

When the arithmetic device 20 executes at least a part of the arithmetic processing, before the execution, the communication controller 131 causes the communication device 170 to transmit a script language program corresponding to the compile language program describing the procedure of the arithmetic processing stored in the storage device 140 to the arithmetic device 20.

The calculator 139 executes at least a part of the above-described arithmetic processing.

Specifically, when the execution instructor 138 instructs the arithmetic device 20 to execute at least a part of the arithmetic processing, the calculator 139 executes the remaining arithmetic processing as a remainder by deducting the part of the arithmetic processing executed by the arithmetic device 20 from the arithmetic processing.

In contrast, when the execution instructor 138 instructs the calculator 139 to execute all the arithmetic processing among the above-described arithmetic processing, the calculator 139 executes all the arithmetic processing among the above-described arithmetic processing.

### 1-2: Operation in First Embodiment

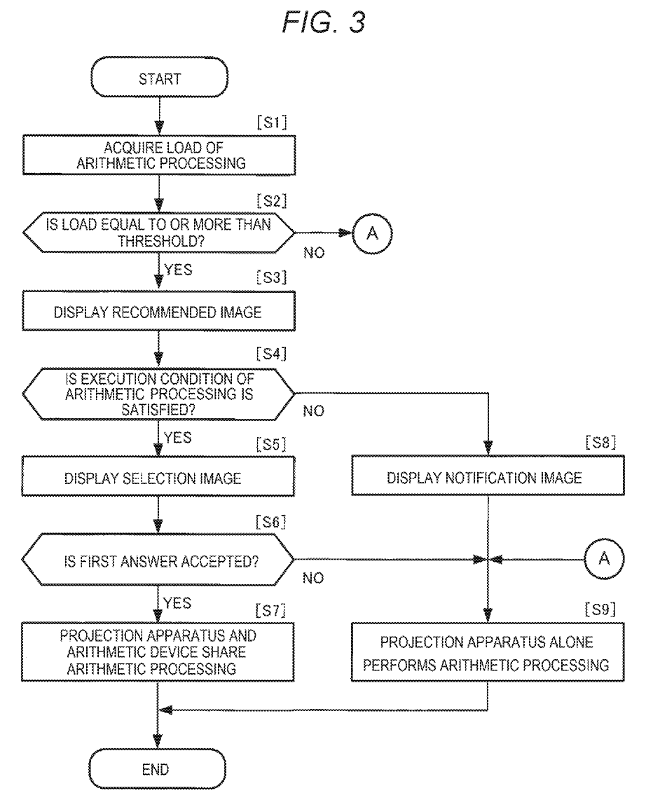

FIG. 3 is a flowchart showing an operation example of the display system 1.

In step S1, the processing device 130 provided in the projection apparatus 10 functions as the acquirer 132. The processing device 130 refers to the load table DT stored in the storage device 140 based on the type of arithmetic processing to be executed, and acquires a numerical value indicating the load corresponding to the arithmetic processing.

In step S2, the processing device 130 functions as the first determiner 133. The processing device 130 compares the numerical value indicating the load acquired in step S1 with the threshold. When the numerical value indicating the load is equal to or more than the threshold (YES in step S2), the processing device 130 executes processing in step S3. In contrast, when the numerical value indicating the load is less than the threshold (NO in step S2), the processing device 130 executes processing in step S9.

In step S3, the processing device 130 functions as the display controller 134. The processing device 130 displays the recommended image described above on the projection surface PF.

In step S4, the processing device 130 functions as the second determiner 135. The processing device 130 determines whether the arithmetic device 20 satisfies a condition for executing at least a part of the above-described arithmetic processing. When the processing device 130 determines that the arithmetic device 20 satisfies the condition (YES in step S4), the processing device 130 executes processing in step S5. When the processing device 130 determines that the arithmetic device 20 does not satisfy the condition (NO in step S4), the processing device 130 executes processing in step S8.

In step S5, the processing device 130 functions as the display controller 134. The processing device 130 displays a selection image that receives an answer for the arithmetic device 20 to execute at least a part of the arithmetic processing (first answer) or an answer for the arithmetic device not to execute the arithmetic processing (second answer) from the user on the projection surface PF.

In step S6, the processing device 130 functions as the receiver 136. The processing device 130 receives the first answer or the second answer. The processing device 130 functions as the third determiner 137. The processing device 130 determines whether the first answer is received or the second answer is received via the selection image. When the first answer is received (YES in step S6), the display system 1 executes an operation in step S7. When the second answer is received (NO in step S6), the display system 1 executes the processing in step S9.

In step S7, the projection apparatus 10 and the arithmetic device 20 share the arithmetic processing. Specifically, the arithmetic device 20 executes at least a part of the arithmetic processing. The projection apparatus 10 executes the remaining arithmetic processing among the arithmetic processing.

An example of the processing in step S7 will be described. For example, it is assumed that the arithmetic processing is processing related to geometric correction. Specifically, this is an example in which geometric correction is performed based on a result of imaging of a structured light pattern projected from the projection apparatus 10 onto the projection surface PF by the imaging device 120. In this case, for example, the projection apparatus 10 causes the projector 110 to project the structured light pattern, causes the imaging device 120 to image the structured light pattern projected on the projection surface PF, and transmits the result (imaging data) of the imaging by the imaging device 120 to the arithmetic device 20. In contrast, the arithmetic device 20 calculates a correspondence relationship (projective transformation matrix) that associates the coordinate system of the liquid crystal panel with the coordinate system of the imaging element based on the received imaging data, calculates a deformation amount for deforming the structured light pattern in which the trapezoidal distortion occurs in the imaging data into a rectangle, transforms the deformation amount into the coordinate system of the liquid crystal panel based on the correspondence relationship, and transmits information indicating the transformed deformation amount to the projection apparatus 10. The projection apparatus 10 performs geometric correction based on the received information.

In step S8, the processing device 130 functions as the display controller 134. The processing device 130 displays a notification image for notifying the arithmetic device 20 to stop sharing at least a part of the arithmetic processing on the projection surface PF.

In step S9, the projection apparatus 10 alone executes arithmetic processing.

### 2: Modifications

The embodiment described above can be variously modified. Specific configurations of the modifications will be exemplified below. The configurations exemplified below and the configurations described in the embodiment can be combined as appropriate without contradicting each other. Note that, in the modifications exemplified below, elements having effects and functions equivalent to those of the embodiment are denoted by the signs referred to in the above description and the detailed description of the elements is omitted as appropriate.

### 2-1: Modification 1

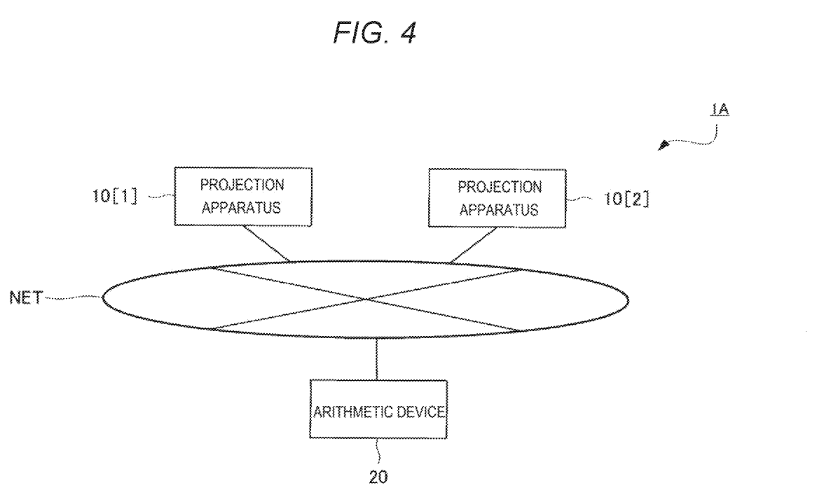

FIG. 4 is a block diagram showing a configuration example of a display system 1A according to the present modification. As shown in FIG. 4, the display system 1A may include two projection apparatuses 10 of a projection apparatus 10[1] and a projection apparatus 10[2] in order to execute multi-projection. The projection apparatus 10[1], the projection apparatus 10[2], and the arithmetic device 20 may be communicably connected via a communication network NET. That is, the projection apparatus 10[1] and the arithmetic device 20 may be connected via the communication network NET instead of being directly connected. Similarly, the projection apparatus 10[2] and the arithmetic device 20 may be connected via the communication network NET instead of being directly connected.

### 2-2: Modification 2

In the above-described embodiment, the second determiner 135 determines whether the arithmetic device 20 satisfies the condition for executing at least a part of the above-described arithmetic processing based on various types of information acquired by the acquirer 132 from the arithmetic device 20. However, the projection apparatus 10 and the arithmetic device 20 may perform a test of performance of arithmetic processing, and the second determiner 135 may determine whether the arithmetic device 20 satisfies a condition for executing at least a part of the arithmetic processing based on a result of the test. In the performance of the arithmetic processing here, it is preferable that a connection environment (line speed or the like) of a line connecting the projection apparatus 10 and the arithmetic device 20 or the communication network NET is also taken into consideration.

### 2-3: Modification 3

The display system 1 shown in FIG. 1 may include, for example, a display such as a television instead of the projection apparatus 10. In this case, the display is an example of the "display apparatus". The display system 1 may include a PC, a tablet, or a smartphone instead of the projection apparatus 10. In this case, the PC, the tablet, or the smartphone is an example of the "display apparatus".

### 2-4: Modification 4

In the display system 1 shown in FIG. 1, the arithmetic device 20 may be an image supply device that supplies an image to the projection apparatus 10. The image supply device is, for example, a PC, a tablet, or a smartphone.

### 2-5: Modification 5

The display system 1 shown in FIG. 1 may further include an information processing apparatus that controls the projection apparatus 10. The information processing apparatus is, for example, a PC, a tablet, or a smartphone. In this case, at least one image of the recommended image, the selection image, and the notification image may be displayed on a display provided in the information processing apparatus or a display connected to the information processing apparatus. The information processing apparatus is an example of the "display apparatus".

### 2-6: Modification 6

In the display system 1 shown in FIG. 1, the projection apparatus 10 displays the recommended image, the selection image, and the notification image on the projection surface PF. However, the projection apparatus 10 may display at least one image of the recommended image, the selection image, and the notification image on the display 150.

### 3: Summary of Present Disclosure

The present disclosure will be summarized below as appendices.

(Appendix 1) A method of controlling a display apparatus includes, before one or more processors of the display apparatus that displays an image start first arithmetic processing, displaying a recommended image for recommending use of an external arithmetic device different from the display apparatus as the image in order to execute at least a part of the first arithmetic processing.

According to the configuration, when it is desired to share the calculation of the display apparatus using the external arithmetic device, the user can easily determine the timing and the situation in which the external arithmetic device should be used.

More specifically, according to the configuration, since the recommended image is displayed before the first arithmetic processing is started, the user can easily grasp that the first arithmetic processing is a calculation that should use the external arithmetic device.

(Appendix 2) The method of controlling a display apparatus according to Appendix 1 includes, after the external arithmetic device is connected to the display apparatus, determining whether the external arithmetic device satisfies a condition for executing at least a part of the first arithmetic processing by the one or more processors, causing the external arithmetic device to execute at least a part of the first arithmetic processing when the one or more processors determine that the external arithmetic device satisfies the condition, and executing the first arithmetic processing only by the one or more processors when the one or more processors determine that the external arithmetic device does not satisfy the condition.

According to the configuration, the display apparatus can execute appropriate control according to whether the external arithmetic device satisfies the condition for executing at least a part of the first arithmetic processing.

(Appendix 3) The method of controlling a display apparatus according to Appendix 2, further includes after the external arithmetic device is connected to the display apparatus and before the one or more processors determine whether the external arithmetic device satisfies the condition, acquiring performance information indicating first arithmetic performance as arithmetic performance of the external arithmetic device, wherein the condition is that the first arithmetic performance indicated by the performance information is equal to or more than second arithmetic performance as arithmetic performance of the one or more processors.

According to the configuration, the display apparatus can execute appropriate control according to the difference between the performance of the one or more processors and the performance of the external arithmetic device.

(Appendix 4) The method of controlling a display apparatus according to Appendix 2 or 3, further includes, after the external arithmetic device is connected to the display apparatus and before the one or more processors determine whether the external arithmetic device satisfies the condition, acquiring license information indicating whether the external arithmetic device has a license of application software for executing at least a part of the first arithmetic processing, wherein the condition is that the license information indicates that the external arithmetic device has the license.

According to the configuration, the display apparatus can execute appropriate control according to the presence or absence of the license of application software in the external arithmetic device.

(Appendix 5) The method of controlling a display apparatus according to any one of Appendices 2 to 4, further includes, after the external arithmetic device is connected to the display apparatus and before the one or more processors determine whether the external arithmetic device satisfies the condition, acquiring installation information indicating an installation status of application software for executing at least a part of the first arithmetic processing in the external arithmetic device, wherein the condition is that the installation information indicates that the application software is installed in the external arithmetic device.

According to the configuration, the display apparatus can execute appropriate control according to the installation status of the application software in the external arithmetic device.

(Appendix 6) The method of controlling a display apparatus according to any one of Appendices 2 to 5, further includes, after the external arithmetic device is connected to the display apparatus and before the one or more processors determine whether the external arithmetic device satisfies the condition, acquiring graphics processing unit (GPU) information indicating a provision status of a GPU in the external arithmetic device, wherein the condition is that the GPU information indicates that the GPU is provided in the external arithmetic device.

According to the configuration, the display apparatus can execute appropriate control according to the provision status of the GPU in the external arithmetic device.

(Appendix 7) The method of controlling a display apparatus according to any one of Appendices 2 to 6, further includes, when the one or more processors determine that the external processing device satisfies the condition, after the determination and before the external processing device is caused to execute at least a part of the first processing, causing the display apparatus to display a selection image that receives a first answer for the external arithmetic device to execute at least a part of the first arithmetic processing or a second answer for the external arithmetic device not to execute the at least a part of the first arithmetic processing, wherein the causing the external arithmetic device to execute at least a part of the first arithmetic processing includes causing the external arithmetic device to execute at least a part of the first arithmetic processing when the one or more processors determine that the first answer is received via the selection image, and the executing of the first arithmetic processing only by the one or more processors includes executing the first arithmetic processing only by the one or more processors when the one or more processors determine that the second answer is received via the selection image.

According to the configuration, the user can determine to cause the external arithmetic device to actually execute at least a part of the first arithmetic processing by the selection image for selecting whether to actually execute the first arithmetic processing.

(Appendix 8) The method of controlling a display apparatus according to any one of Appendices 2 to 7, further includes, after the one or more processors determine that the external processing device satisfies the condition and before the external processing device is caused to execute at least a part of the first processing, transmitting a script language program corresponding to a compile language program describing a procedure of the first arithmetic processing stored in a storage device to the external arithmetic device.

According to the configuration, the external arithmetic device can execute at least a part of the first arithmetic processing.

(Appendix 9) A display system includes a display apparatus including one or more processors, and, before starting first arithmetic processing, displaying a recommended image for recommending use of an external arithmetic device different from the display apparatus in order to execute at least a part of the first arithmetic processing, and the external arithmetic device.

According to the configuration, when it is desired to share the calculation of the display apparatus using the external arithmetic device, the user can easily determine the timing and the situation in which the external arithmetic device should be used.

More specifically, according to the configuration, since the recommended image is displayed before the first arithmetic processing is started, the user can easily grasp that the first arithmetic processing is a calculation that should use the external arithmetic device.

What is claimed is:

1. A method of controlling a display apparatus comprising, before one or more processors of the display apparatus that displays an image start first arithmetic processing, displaying a recommended image for recommending use of an external arithmetic device different from the display apparatus as the image in order to execute at least a part of the first arithmetic processing.

2. The method of controlling a display apparatus according to claim 1, further comprising:
after the external arithmetic device is connected to the display apparatus, determining, by the one or more processors, whether the external arithmetic device satisfies a condition for executing at least a part of the first arithmetic processing;
causing the external arithmetic device to execute at least a part of the first arithmetic processing when the one or more processors determine that the external arithmetic device satisfies the condition; and
executing the first arithmetic processing only by the one or more processors when the one or more processors determine that the external arithmetic device does not satisfy the condition.

3. The method of controlling a display apparatus according to claim 2, further comprising, after the external arithmetic device is connected to the display apparatus and before the one or more processors determine whether the external arithmetic device satisfies the condition, acquiring performance information indicating first arithmetic performance as arithmetic performance of the external arithmetic device, wherein
the condition is that the first arithmetic performance indicated by the performance information is equal to or more than second arithmetic performance as arithmetic performance of the one or more processors.

4. The method of controlling a display apparatus according to claim 2, further comprising, after the external arithmetic device is connected to the display apparatus and before the one or more processors determine whether the external arithmetic device satisfies the condition, acquiring license information indicating whether the external arithmetic device has a license of application software for executing at least a part of the first arithmetic processing, wherein
the condition is that the license information indicates that the external arithmetic device has the license.

5. The method of controlling a display apparatus according to claim 2, further comprising, after the external arithmetic device is connected to the display apparatus and before the one or more processors determine whether the external arithmetic device satisfies the condition, acquiring installation information indicating an installation status of application software for executing at least a part of the first arithmetic processing in the external arithmetic device, wherein
the condition is that the installation information indicates that the application software is installed in the external arithmetic device.

6. The method of controlling a display apparatus according to claim 2, further comprising, after the external arithmetic device is connected to the display apparatus and before the one or more processors determine whether the external arithmetic device satisfies the condition, acquiring graphics processing unit (GPU) information indicating a provision status of a GPU in the external arithmetic device, wherein
the condition is that the GPU information indicates that the GPU is provided in the external arithmetic device.

7. The method of controlling a display apparatus according to claim 2, further comprising, when the one or more processors determine that the external processing device satisfies the condition, after the determination and before the external processing device is caused to execute at least a part of the first processing, causing the display apparatus to display a selection image that receives a first answer for the external arithmetic device to execute at least a part of the first arithmetic processing or a second answer for the external arithmetic device not to execute the at least a part of the first arithmetic processing, wherein
the causing the external arithmetic device to execute at least a part of the first arithmetic processing includes causing the external arithmetic device to execute at least a part of the first arithmetic processing when the one or more processors determine that the first answer is received via the selection image, and
the executing of the first arithmetic processing only by the one or more processors includes executing the first arithmetic processing only by the one or more processors when the one or more processors determine that the second answer is received via the selection image.

8. The method of controlling a display apparatus according to claim 2, after the one or more processors determine that the external processing device satisfies the condition and before the external processing device is caused to execute at least a part of the first processing, transmitting a script language program corresponding to a compile language program describing a procedure of the first arithmetic processing stored in a storage device to the external arithmetic device.

9. A display system comprising:
a display apparatus including one or more processors, and, before starting first arithmetic processing, displaying a recommended image for recommending use of an external arithmetic device different from the display apparatus in order to execute at least a part of the first arithmetic processing; and
the external arithmetic device.
